(19) United States
(12) Patent Application Publication
(10) Pub. No.: US 2010/0028067 A1
(43) Pub. Date: Feb. 4, 2010

(54) Printing Device, Printing System, and Near-End Notification Method

(75) Inventors: Hiroshi Wanibuchi, Matsumoto-shi (JP); Shin Takeuchi, Azumino-shi (JP); Haruyoshi Ohori, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/534,058

(22) Filed: Jul. 31, 2009

(30) Foreign Application Priority Data
Aug. 1, 2008 (JP) 2008-199162
Aug. 1, 2008 (JP) 2008-199163
Aug. 1, 2008 (JP) 2008-199164

(51) Int. Cl. B41J 11/00

(52) U.S. Cl. 400/621

(57) ABSTRACT

The user can learn when the end of the roll paper is near even when using roll paper that does not already have near-end markings. The printer 101 has a thermal head 8 that prints print data sent from a host computer 90 on roll paper 7, a near-end detector 17 that detects the near-end of the roll paper 7, and a near-end printing control unit 53. When printing on the roll paper 7 after the near-end is detected by the near-end detector 17, the near-end printing control unit 53 causes the thermal head 8 to print a near-end pattern 65 indicating the near-end of the roll.

### BACKGROUND OF THE INVENTION

1. Technical Field The present invention relates to technology for informing the user of when the end of the roll paper is near, that is, a near-end condition.

2. Related Art

Printers that print text and graphics to roll paper using a line thermal head, cut the printed roll paper, and discharge the cut portion from a paper exit are known from the literature. Such printers are commonly used in POS systems that print sales receipts, and devices such as automatic teller machines (ATM) and cash dispensers (CD).

In order to inform the user of a near-end condition in which there is little roll paper left and prompt the user to replace the paper, a band of color, typically red, is formed along the edge of the paper for a specific length from the end of the roll during the roll paper manufacturing process. See, for example, Japanese Unexamined Patent Appl. Pub. JP-A-2005-59233.

Linerless label paper, that is, label paper without backing paper for the labels, is also used in roll paper form. This type of label paper has adhesive applied to the entire back side of the roll paper. In order to easily peel the adhesive from the label surface, a release coating is applied to the label surface of the roll paper. This release coating has a low affinity with the coating that is used for the near-end markings, thus preventing rendering the near-end markings on the label surface.

### SUMMARY

A printing device, a printing system, and a near-end notification method according to the present invention enable the user to know the end of the roll paper is near even when using roll paper that does not have preformed near-end markings.

A printing device according to one aspect of the invention has a printing unit that prints print data on roll paper; a near-end detection unit that detects the near-end of the roll paper; and a printing control unit that causes the printing unit to print a near-end pattern, mark, or advertisement indicating the near-end when printing on the roll paper after the near-end has been detected by the near-end detection unit.

When the near-end is detected in this aspect of the invention, a near-end pattern, mark, or advertisement is printed by the printing unit when printing on roll paper. This enables the user to know from the appearance of the near-end pattern, mark, or advertisement that end of the roll paper is near.

In addition, because the near-end of the roll paper is reported by printing a near-end pattern, it is not necessary to render near-end markings on the roll paper during the paper manufacturing process. The productivity of the roll paper manufacturing process is thus improved. The user can also be reliably informed of the near-end of the paper even when using roll paper (such as linerless label paper) on which forming near-end markings can be difficult due to low affinity with the coating conventionally used to apply the near-end markings.

A printing device according to another aspect of the invention preferably also has a cutting unit that cuts the roll paper printed by the printing unit, and the printing control unit causes the printing unit to print the mark denoting the near-end at or near the cutting position of the cutting unit.

Because the marks denoting the near-end mark are printed at or near where the roll paper is cut in this aspect of the invention, the near-end mark is less conspicuous than the near-end markings used by conventional methods, and reporting the near-end can thus be made less intrusive and objectionable to a third party. In addition, if printing occupies the full width of the roll paper and the near-end marking is printed along an edge of the roll paper, the marking can easily overlap the printed content. However, because this embodiment of the invention prints the near-end mark at or near the paper cutting position, the near-end mark will not be superimposed with other printed content and the quality of the printout will not be impaired.

In a printing device according to another aspect of the invention, the printing control unit causes the printing unit to change and print a near-end pattern, mark, or advertisement according to how much roll paper remains.

Because the near-end pattern, mark, or advertisement denoting the near-end changes according to how much roll paper remains after the near-end is detected, the user can know based on this change how much roll paper remains. The user can also replace the roll paper timed to when the roll paper is sufficiently completely consumed to prevent running out of roll paper while printing.

A printing device according to another aspect of the invention preferably also has a configuration unit for setting whether or not to print the near-end pattern, mark, or advertisement.

This aspect of the invention enables setting prohibiting printing a near-end pattern, mark, or advertisement denoting the near-end. This enables not printing the near-end pattern, mark, or advertisement for a period of time, or not printing the near-end pattern, mark, or advertisement when using roll paper that already has near-end markings.

In a printing device according to another aspect of the invention, the configuration unit sets whether or not to print the near-end pattern, mark, or advertisement according to the printout.

By appropriately setting the configuration unit, this aspect of the invention enables controlling whether or not the near-end pattern, mark, or advertisement is printed according to the content of the printout. This enables not printing the near-end mark or pattern only when it would interfere with the desired printout, such as when the value of the printout (such as a coupon) would be reduced by printing a near-end pattern, mark, or advertisement or printing a near-end pattern, mark, or advertisement in the desired printout would be annoying.

In a printing device according to another aspect of the invention, the printing control unit causes the printing unit to print the advertisement in a specified print color when printing the print data on the roll paper, and when the near-end is detected by the near-end detection unit, causes the printing unit to print an advertisement indicating the near-end by changing the print color of the advertisement.

After the near-end is detected, this aspect of the invention changes the print color of an advertisement that is printed in a specified print color while printing to roll paper. As a result, the user can know that the end of the roll paper is near from the change in the print color of the advertisement. Third parties (such as customers) other than the user will simply recognize the advertisement as an advertisement, will not be aware of the near-end notification, and more particularly can perceive the advertisement as useful information.

In a printing device according to another aspect of the invention, the printing control unit determines the print color according to how much roll paper remains when changing the print color of the advertisement.

This aspect of the invention enables the user to know how much roll paper is left based on the color of the advertisement because the color used to print the advertisement is changed according to the length of remaining roll paper after the near-end is detected. As a result, the user can also replace the roll paper timed to when the roll paper is sufficiently completely consumed to prevent running out of roll paper while printing.

In a printing device according to another aspect of the invention the printing unit has an inkjet head that discharges ink to the printing surface of the roll paper, and an ink cartridge that stores ink of plural colors and supplies the ink to the inkjet head; and the printing control unit determines the print color according to how much of each color of ink remains in the ink cartridge when changing the print color of the advertisement.

This aspect of the invention changes the print color of the advertisement after the near-end is detected according to how much ink of each color is left. Therefore, by changing the print color of the advertisement to the color of the ink with the largest remaining volume, the ink with the greatest volume is consumed before the other colors of ink so that the remaining ink volumes can be evened out. The user can then replace the ink cartridge after each color of ink is sufficiently depleted.

Another aspect of the invention is a printing system including a host device that generates print data, and a printing device. The printing device has a printing unit for printing print data sent from the host device on roll paper, a near-end detection unit that detects the near-end of the roll paper, and a printing control unit that causes the printing unit to print a near-end pattern, mark, or advertisement indicating the near-end when printing on the roll paper after the near-end has been detected by the near-end detection unit.

The printing device of the printing system preferably also has a cutting unit that cuts the roll paper printed by the printing unit, and the printing control unit causes the printing unit to print the mark denoting the near-end at or near the cutting position of the cutting unit.

In the printing system according to another aspect of the invention, the printing control unit causes the printing unit to print the advertisement in a specified print color when printing the print data on the roll paper, and when the near-end is detected by the near-end detection unit, causes the printing unit to print an advertisement indicating the near-end by changing the print color of the advertisement.

Another aspect of the invention is a near-end notification method for a printing device that prints print data on roll paper, the near-end notification method printing a near-end pattern, mark, or advertisement indicating a near-end when printing on the roll paper after the near-end of the roll paper has been detected.

The near-end notification method according to another aspect of the invention prints the mark denoting the near-end at or near the cutting position where the roll paper on which the print data is printed is cut.

The near-end notification method according to another aspect of the invention changes and prints the near-end pattern, mark, or advertisement according to how much roll paper remains.

In the near-end notification method according to yet another aspect of the invention, the advertisement is printed in a specified print color when printing the print data on the roll paper, and when the near-end is detected by the near-end detection unit, changes the print color of the advertisement to print an advertisement indicating the near-end.

A control program according to another aspect of the invention causes a printing device that has a printing unit that prints print data on roll paper and a near-end detection unit that detects the near-end of the roll paper to function as a printing control unit that causes the printing unit to print a near-end pattern, mark, or advertisement indicating the near-end when printing on the roll paper after the near-end has been detected by the near-end detection unit.

Effect of the Invention

When the near-end of the paper is detected, the invention prints a near-end pattern, mark, or advertisement when printing to the roll paper. The invention thus enables the user to know from the appearance of the near-end pattern, mark, or advertisement that the end of the roll paper is near even when using roll paper without near-end markings.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows the configuration of a printing system according to a preferred embodiment of the invention.

FIG. 2 is an oblique view showing the printer frame.

FIG. 3 is a vertical section view showing the internal configuration of the printer.

FIG. 4 is a block diagram showing the functional configuration of the printer.

FIG. 5 is a flow chart of the recording operation of the printer.

FIG. 6A to FIG. 6C describe printing the near-end pattern.

FIG. 7A to FIG. 7D illustrate variations of the near-end pattern.

FIG. 8 is a block diagram showing the functional configuration of a printing system according to a second embodiment of the invention.

FIG. 9 is a flow chart of the recording operation of the printer.

FIG. 10A to FIG. 10D illustrates printing the near-end pattern.

FIG. 11A to FIG. 11E illustrate printing other near-end patterns.

FIG. 12 shows the configuration of a printing system according to a third embodiment of the invention.

FIG. 13 is an external oblique view showing the printer with the access cover open.

FIG. 14 is a vertical section view showing the internal configuration of the printer.

FIG. 15 is a block diagram showing the functional configuration of the printing system.

FIG. 16 is a flow chart of the recording operation of the printer.

FIG. 17 is a flow chart of the operation that changes the advertisement print color.

FIG. 18A to FIG. 18C show examples of receipts printed with an advertisement.

FIG. 19 is a flow chart of the recording operation according to a fourth embodiment of the invention.

### DESCRIPTION OF EMBODIMENTS

Preferred embodiments of the present invention are described below with reference to the accompanying figures.

### Embodiment 1

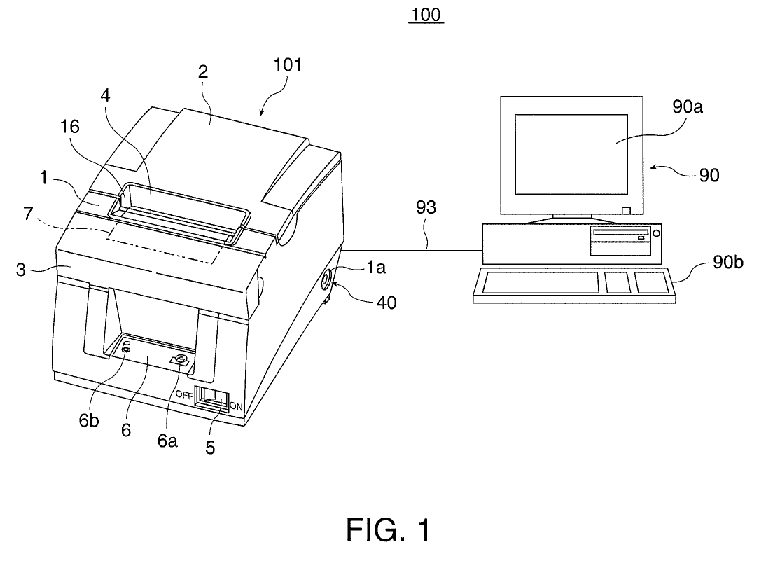

FIG. 1 shows the configuration of a printing system 100 according to the present invention.

The printing system 100 includes a host computer 90 as a host device, and a printer 101 that is connected to the host computer 90 through a communication cable 93. The printing system 100 is, for example, used advantageously for issuing receipts 375 in a POS system used in restaurants and retail stores such as supermarkets.

The host computer 90 sends print data and control data to the printer 101 through the communication cable 93, and controls the printer 101 to print images on a recording medium. If the printing system 100 is used in a. POS system, print data including transaction data such as the names of the purchased products and the purchase price is sent from the host computer 90 to the printer 101.

The host computer 90 is a computer system including a display 90a (display screen) for displaying images and video, and a keyboard 90b that is operated by the user.

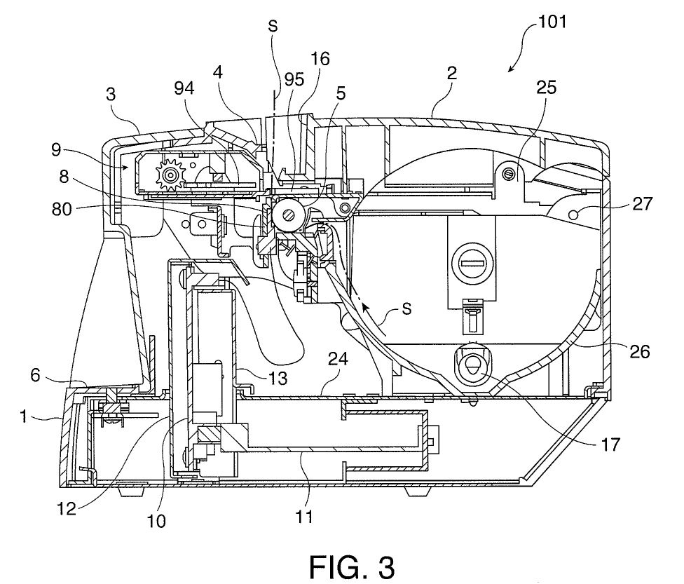

The printer 101 is, for example, a roll paper printer that uses roll paper 7 having linerless label paper wound in a roll as the recording medium and prints by transferring heat from a thermal head 8 (see FIG. 3) to the printing surface of the roll paper 7.

As shown in FIG. 1 the printer 101 has a box-like exterior with a roll paper cover 2 and paper cutter cover 3 assembled in the main case 1, and a paper exit 16 from which the roll paper 7 is discharged after printing is formed in the top. A manual cutter 4 with a knife blade is disposed to the paper exit 16, and the roll paper 7 is pressed and cut against the cutting edge of the manual cutter 4. Various switches and indicators, such as a power switch and other operating switches, are disposed at the front of the printer 101.

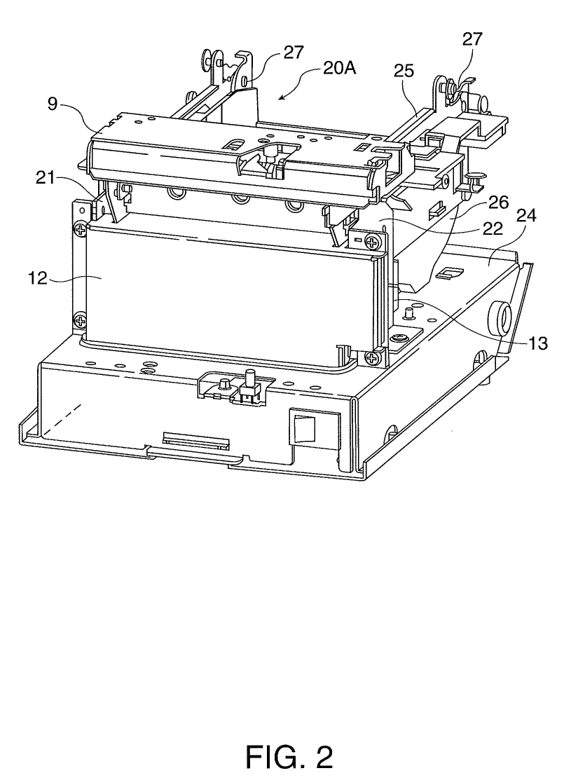

FIG. 2 is an oblique view showing the configuration of the printer 101 frame.

The main frame 20A of the printer 101 includes a box-shaped base frame 24, and a left side frame 21 and right side frame 22 disposed in mutual opposition at the top of the base frame 24. A roll paper holder 26 that holds the roll paper 7 so that it can rotate is disposed at the back part of the left side frame 21 and right side frame 22. A roll paper cover frame 25 to which the foregoing roll paper cover 2 is attached is disposed at the top of the roll paper holder 26. The roll paper cover 2 can pivot open and closed with the roll paper cover frame 25 on a hinge 27, and when the roll paper cover 2 is open, the roll paper holder 26 is open and the roll paper 7 can be set inside. An automatic cutting unit 9 is disposed as a paper cutting mechanism at the front part of the left side frame 21 and right side frame 22.

FIG. 3 is a section view of the printer.101.

The printer 101 has a head frame 80 disposed between the left side frame 21 and right side frame 22, and the thermal head 8 is disposed to this head frame 80. The thermal head 8 has numerous heating elements (not shown in the figure) disposed along its length (widthwise to the roll paper 7), and records images including text by heating the roll paper 7 when pressed against the printing side of the roll paper 7. A main circuit board 10, which is the control circuit board controlling the printer 101, is disposed to the base frame 24 between a front circuit board cover 12 and rear circuit board cover 13. An interface board 11 enabling connecting other devices is also connected to the main circuit board 10.

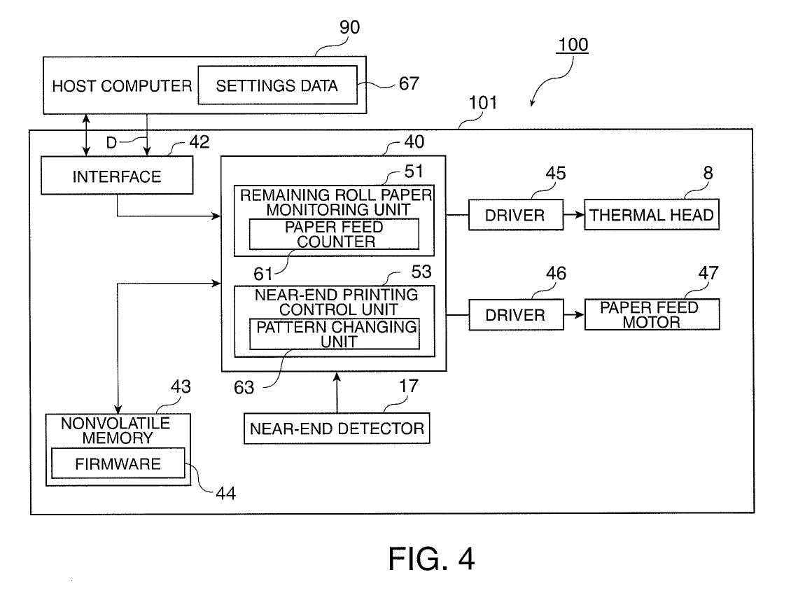

A round platen 5 is disposed at a position opposite the thermal head 8, and the platen 5 also functions as a roll paper 7 transportation mechanism. More specifically, the platen 5 is disposed so that it can be urged toward the thermal head 8 while being driven rotationally by the paper feed motor 47 (see FIG. 4), and the leading end of the roll paper 7 pulled from the roll paper holder 26 is held between the platen 5 and thermal head 8. As the platen 5 is then driven rotationally, the roll paper 7 is pulled sequentially through the transportation path S from the roll paper holder 26, is printed on by the thermal head 8, and is discharged from the paper exit 16. The automatic cutting unit 9, which includes a movable knife 94 and fixed knife 95 and automatically cuts the roll paper 7 discharged from the paper exit 16, is disposed to the paper exit 16, and the roll paper 7 thus cut after printing can be issued as a receipt or coupon, for example.

A near-end detector 17 that detects when the end of the roll paper 7 is near is also disposed to the roll paper holder 26, and the detection signal from the near-end detector 17 is input to the main circuit board 10. The near-end detector 17 includes a limit switch (not shown in the figure) that turns on at a position relative to the height of the core of the roll paper 7 in the roll paper holder 26. The limit switch is set to turn on when the height of the core descends to a specific position in conjunction with roll paper 7 consumption, that is, when the amount of remaining roll paper 7 reaches a specific level. The detection signal from this limit switch is input to the main circuit board 10. By adjusting the height of the core at which the limit switch turns on, the amount of remaining roll paper 7 that is detected as the near-end can be adjusted.

FIG. 4 is a block diagram showing the functional configuration of the printing system 100.

The printer 101 has a control unit 40 including a CPU, ROM, and RAM disposed to the main circuit board 10. Print data and other signals are supplied from the host computer 90 to the control unit 40 through an interface 42. The near-end detector 17 is connected to the input side of the control unit 40, and the control unit 40 detects the near-end of the roll paper 7 based on input signals from the near-end detector 17. Nonvolatile memory 43 that stores firmware 44 as the control program is connected to the control unit 40. The thermal head 8 (print unit) and paper feed motor 47 are connected to the output side of the control unit 40 through a head driver 45 and motor driver 46.

The control unit 40 controls the printing operation of the thermal head 8 to roll paper 7, and has a remaining roll paper monitoring unit 51 and a near-end printing control unit 53.

The remaining roll paper monitoring unit 51 monitors the paper feed distance of the roll paper 7 after the near-end is detected by the near-end detector 17, and has a paper feed counter 61. The paper feed counter 61 counts the number of steps that the paper feed motor 47 is controlled to drive in the paper feed direction, and monitors the total paper feed distance of the roll paper 7 by calculating the total number of steps (cumulative total) driven by the paper feed motor 47.

When the near-end is detected by the near-end detector 17, the near-end printing control unit 53 controls printing a near-end pattern 65 indicating the near-end of the paper by the thermal head 8 on the roll paper 7 when printing after the near-end is detected.

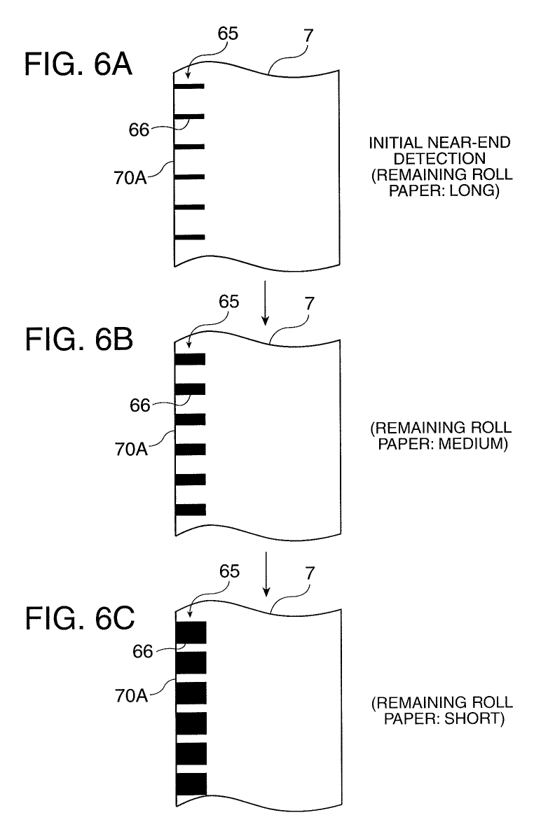

The near-end printing control unit 53 includes a pattern changing unit 63 that changes the pattern (such as the design or shape) printed as the near-end pattern 65 (see FIG. 6) based on how much roll paper 7 is left. By changing the near-end pattern 65 the user can know how much roll paper 7 remains. Note that the near-end pattern 65 can be anyone or combination of designs, shapes, symbols, or characters drawn along the edge of the roll paper 7. When the pattern of the near-end pattern 65 including a plurality of symbols or characters is changed, the pattern can be changed by changing the order of the symbols or characters.

The printing system 100 is configured so that prohibiting printing the near-end pattern 65 on the printout can be set when the printout is a specific type of content, such as a coupon. In this embodiment of the invention the host computer 90 functions as a configuration unit that sets whether or not the the near-end pattern 65 can be printed. More specifically, the host computer 90 stores settings data 67 that includes the printout for which printing the near-end pattern 65 is prohibited as a configuration setting, and when the printout specified by this settings data 67 is printed, a prohibition flag indicating that printing the near-end pattern 65 is prohibited is included in the print data sent to the printer 101.

When this prohibition flag is included in the print data, the control unit 40 prohibits printing the near-end pattern 65 even if the near-end is detected by the near-end detector 17. As a result, by appropriately configuring the settings data 67, the user can, for example, selectively cause the printer 101 to print the near-end pattern 65 when the printout is a normal receipt, and prohibit the printer 101 from printing the near-end pattern 65 when the printed content has added value, such as a coupon.

It should be noted that the host computer 90 stores the settings data 67 in the embodiment described above, but the invention is not so limited and the settings data 67 may alternatively be stored in RAM in the printer 101, for example.

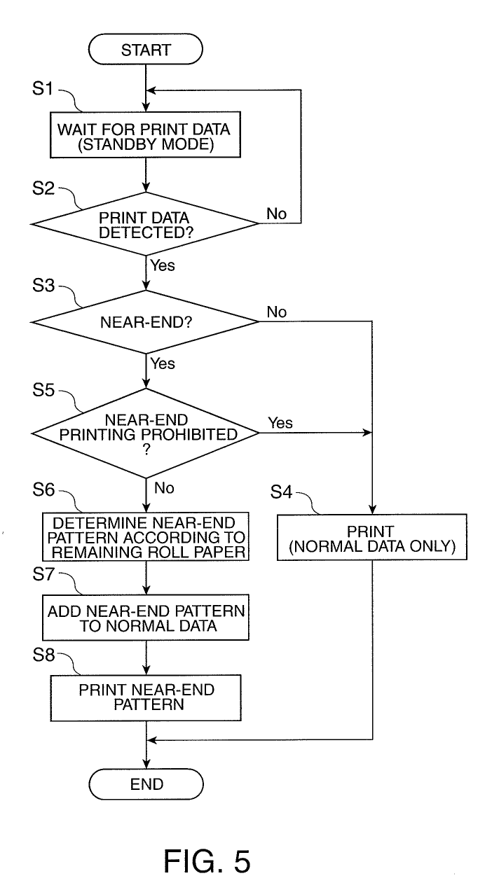

The printing operation of the printer 101 is described next with reference to FIG. 5.

The control unit 40 enters a standby mode when the power turns on (step S1), and waits to receive print data from the host computer 90 (step S2 returns No). When the control unit 40 receives print data from the host computer 90 while in the standby mode (step S2 returns Yes), it determines if the near-end of the roll paper 7 has been detected by the near-end detector 17 (step S3).

If the near-end has not been detected (step S3 returns No), the remaining amount of roll paper 7 is sufficient, the near-end pattern 65 is not printed on the roll paper 7, and printing proceeds as usual according to the print data. More specifically, the control unit 40 prints on the roll paper 7 based on the text data and image data (the “normal data” below) contained in the print data to be printed (step S4).

If the near-end has been detected (step S3 returns Yes), the control unit 40 determines if printing the near-end pattern 65 is prohibited based on whether or not the prohibition flag is contained in the print data received from the host computer 90 (step S5). If printing the near-end pattern 65 is prohibited (step S5 returns Yes), the control unit 40 goes to step S4 and prints as usual, that is, without printing the near-end pattern 65.

If printing the near-end pattern 65 is not prohibited (step S5 returns No), the control unit 40 executes the following steps to inform the user that the end of the roll paper 7 is near by printing the near-end pattern 65.

More specifically, the pattern changing unit 63 gets the detected total paper feed distance of the roll paper 7 printed after the near-end was detected from the remaining roll paper monitoring unit 51 (step S6), and based on this total paper feed distance determines the near-end pattern 65 to be printed (step S7).

Yet more specifically, this embodiment of the invention sets the remaining length of roll paper 7 when the near-end was first detected as the initial remainder, and considers the amount of paper in the range to 30% less than this initial remainder (that is, to 70% of the remainder) to be “long,” the amount from 30% to 70% less than the initial remainder (from 70% to 30%) to be “medium,” and the amount from 70% less than the initial remainder to no remainder (from 30% to 0) to be “short.” A different near-end pattern 65 is assigned to each of these remaining lengths as shown in FIG. 6. In the example shown in FIG. 6, a pattern of horizontal bars 66 printed at substantially equal intervals along the long edge of the roll paper 7 is used as the near-end pattern 65, and the near-end pattern is printed along either the right or left edge part 70A of the roll paper 7. In this near-end pattern 65 as shown in FIG. 6A to FIG. 6C, patterns in which the thickness of the horizontal bars 66 increases as the amount of remaining roll paper 7 decreases are preassigned to the long, medium, and short remaining lengths of roll paper 7. Data corresponding to these near-end pattern 65 is stored in RAM in the control unit 40, for example, or included in the firmware 44. In step S6 the pattern changing unit 63 determines if the roll paper 7 remainder is long, medium, or short and selects the near-end pattern 65 corresponding to the remaining length based on the total amount of roll paper 7 printed after the near-end was detected and the amount of roll paper 7 remaining (initial remainder) when the near-end was first detected. Note that the length of roll paper 7 remaining when the near-end is first detected is predefined as an approximate value based on the height at which the near-end detector detects the roll paper 7 core, and this defined value is used as the initial remainder of the roll paper 7 when the near-end is first detected.

The control unit 40 then generates and adds data for printing the near-end pattern 65 selected by the pattern changing unit 63 to the normal data (step S7), and prints to the roll paper 7 based on this printing data to print the near-end pattern 65 with the normal data (step S8).

As described above, this embodiment of the invention is configured to print a near-end pattern 65 when printing on the roll paper 7 after the near-end of the roll paper 7 is detected by the near-end detector 17. This enables the user of the printer 101 to know from the appearance of the near-end pattern 65 that the end of the roll paper 7 is near.

In addition, because the near-end of the roll paper 7 is reported by printing the near-end pattern 65, it is not necessary to render near-end markings on the roll paper 7 during the paper manufacturing process as is required by the prior art. The productivity of the roll paper 7 manufacturing process is thus improved. The user can also be reliably informed of the near-end of the paper even when using roll paper 7 (such as linerless label paper) on which forming near-end markings can be difficult due to low affinity with the coating conventionally used to apply the near-end markings.

This embodiment of the invention is also configured to change the pattern used as the near-end pattern 65 according to the length of remaining roll paper 7. This embodiment enables the user to know how much roll paper 7 is left based on the near-end pattern 65 after the near-end has been detected. The user can also replace the roll paper 7 timed to when the roll paper 7 is sufficiently completely consumed to prevent running out of roll paper 7 while printing.

This embodiment also enables controlling whether or not the near-end pattern 65 is printed according to the content of the printout. This enables not printing the near-end pattern 65 only when it would interfere with the desired printout, such as when the value of the printout (such as a coupon) would be reduced by printing the near-end pattern 65 or printing the near-end pattern 65 would be annoying in the desired printout.

Note, further, that whether or not the near-end pattern 65 is printed can be set based on conditions other than the printout. For example, printing the near-end pattern 65 may be prohibited when using roll paper 7 on which near-end markings are already provided.

The first embodiment of the invention described above can also be modified as follows.

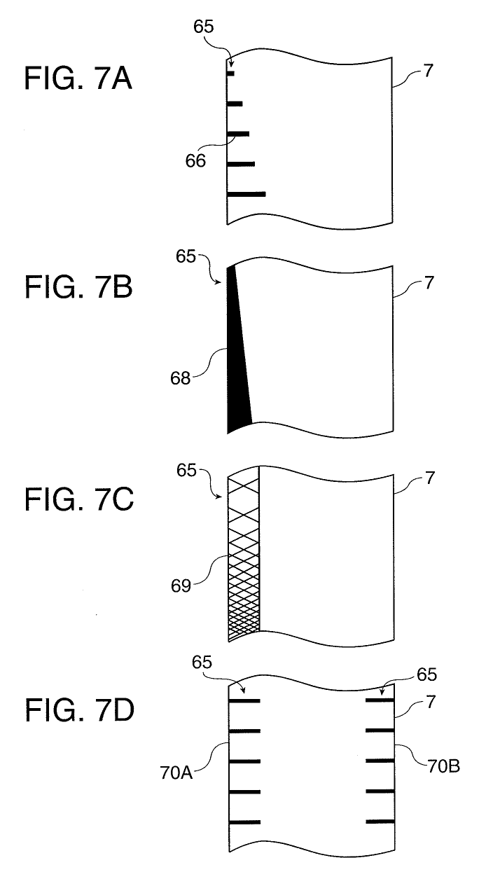

A pattern in which the thickness of the horizontal bars 66 increases according to the remaining length of the roll paper 7 is used as the near-end pattern 65 in the foregoing embodiment, but the invention is not so limited. For example, as shown in FIG. 7A, a pattern in which the length of the horizontal bars 66 increases according to the remaining length of roll paper 7 may be used. Further alternatively, a line 68 that changes in width according to the remaining length of roll paper 7 as shown in FIG. 7B, or a line pattern 69 that changes in line density or darkness according to the remaining length of roll paper 7 as shown in FIG. 7C, may be used as the near-end pattern 65. Further alternatively, different types of designs and graphics, or continuous sequences of characters or symbols, can be used as the near-end pattern 65. Yet further alternatively, the near-end patterns 65 may be printed along both one edge part 70A and the other edge part 70B on the right and left sides of the roll paper 7 as shown in FIG. 7D.

### Embodiment 2

A second embodiment of the invention is described next.

Indicating the near-end of the paper is normally unnecessary from the perspective of the third party (such as the customer) that receives the printout on the roll paper 7 as a receipt or coupon, and adding the near-end markings to the roll paper 7 can conversely be particularly undesirable. More particularly, if near-end markings are added when the printout is issued as something of value, such as a coupon, the value of the coupon may actually be reduced or a poor impression may be made.

This embodiment of the invention describes a printing system 200 that makes the near-end markings less annoying to the third party receiving the printout.

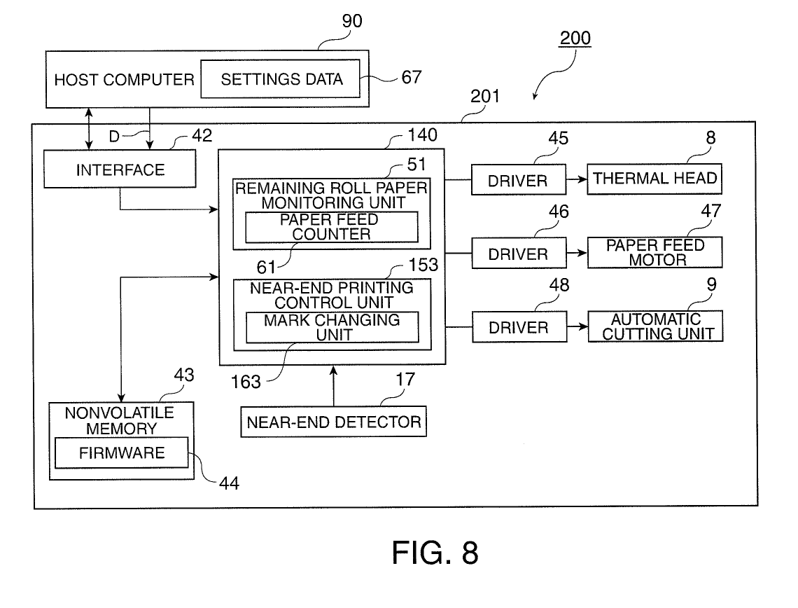

FIG. 8 is a block diagram showing the function configuration of a printing system 200 according to this embodiment of the invention. Note that like parts in FIG. 8 and the block diagram used to described the first embodiment above are identified by the same reference numerals, and further description thereof is omitted or simplified below. The structural configuration of the printing system 200 according to this embodiment of the invention is identical to that of the first embodiment shown in FIG. 1, and the frame configuration and cross sectional configuration of the printer 201 according to this embodiment of the invention are identical to those of the first embodiment shown in FIG. 2 and FIG. 3.

As shown in FIG. 8, an automatic cutting unit driver 48 that drives the automatic cutting unit 9 is connected to the output side of the control unit 140 of the printer 201.

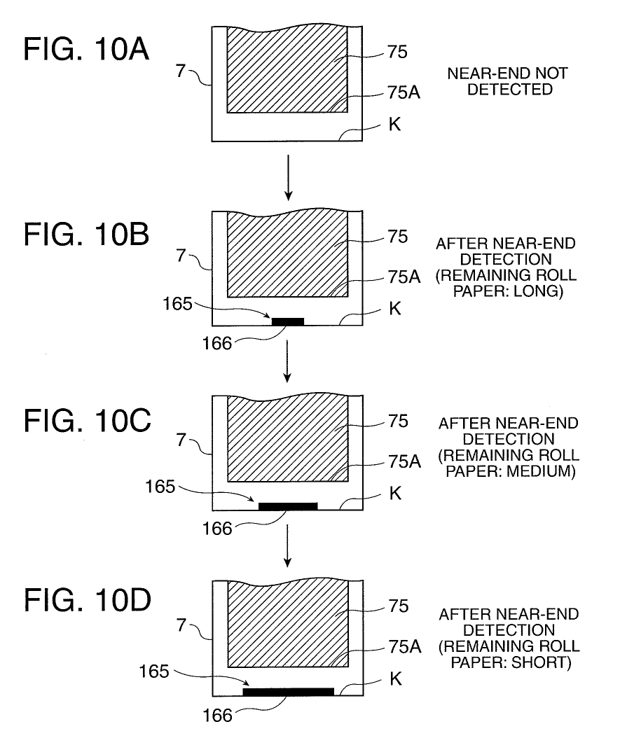

The function of the near-end printing control unit 153 of the control unit 140 differs from the function of the near-end printing control unit 53 in the first embodiment. More specifically, the near-end printing control unit 153 causes the thermal head 8 to print a near-end mark 165 denoting the near-end of the paper at or near the cutting position of the roll paper 7 that is printed thereafter. The near-end printing control unit 153 has a mark changing unit 163, and this mark changing unit 163 changes the shape of the mark printed as the near-end mark 165 (see FIG. 10) based on the length of the remaining roll paper 7. The user can determine how much roll paper 7 is left as a result of changing this near-end mark 165.

As in the first embodiment, the printing system 200 according to this embodiment of the invention is configured so that prohibiting printing the near-end mark 165 on the printout can be set when the printout is a specific type of content, such as a coupon. More specifically, the host computer 90 stores settings data 67 that includes the printout for which printing the near-end mark 165 is prohibited as a configuration setting. When the printout specified by this settings data 67 is printed, a prohibition flag indicating that printing the near-end mark 165 is prohibited is included in the print data sent to the printer 201.

When this prohibition flag is included in the print data, the control unit 140 prohibits printing the near-end mark 165 even if the near-end is detected by the near-end detector 17. As a result, by appropriately configuring the settings data 67, the user can, for example, selectively cause the printer 201 to print the near-end mark 165 when the printout is a normal receipt, and prohibit the printer 201 from printing the near-end mark 165 when the printed content has added value, such as a coupon.

It should be noted that the host computer 90 stores the settings data 67 in the embodiment described above, but the invention is not so limited and the settings data 67 may alternatively be stored in RAM in the printer 201, for example.

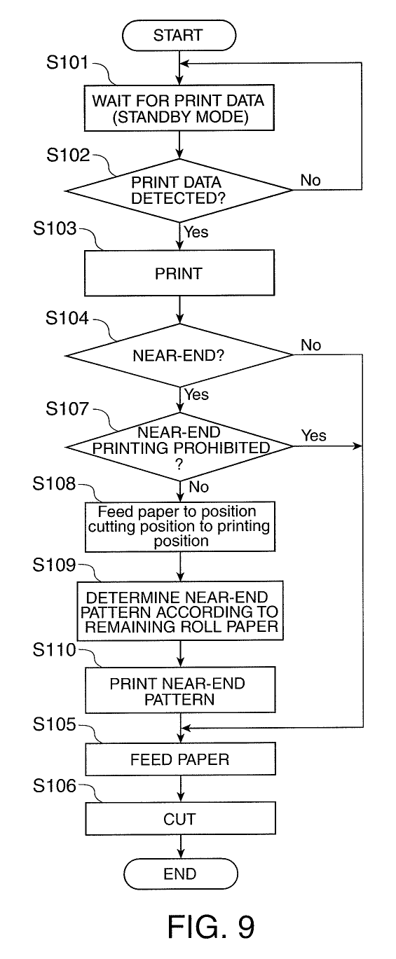

The printing operation of the printer 201 is described next with reference to FIG. 9.

The control unit 140 enters a standby mode when the power turns on (step S101), and waits to receive print data from the host computer 90 (step S102 returns No). When the control unit 140 receives print data from the host computer 90 while in the standby mode (step S102 returns Yes), it prints to the roll paper 7 based on the text data and image data to be printed that is contained in the print data (step S103). Before discharging the paper, the control unit 140 then determines if the near-end of the roll paper 7 has been detected by the near-end detector 17 (step S104).

If the near-end has not been detected (step S104 returns No), the remaining amount of roll paper 7 is sufficient, the near-end mark 165 is not printed on the roll paper 7, and the paper is discharged without printing the near-end mark 165 on the roll paper 7. More specifically, the control unit 140 drives the paper feed motor 47 to advance the roll paper 7. A position separated a predetermined distance from the last line printed on the roll paper 7 is defined as the cutting position K. The control unit 140 advances the paper so that the paper is cut at this cutting position K by the automatic cutting unit 9 (step S105), and then drives the automatic cutting unit 9 to cut the roll paper 7 at the cutting position K (step S106). As a result, as shown in FIG. 10A, the roll paper 7 is cut at the cutting position K separated a predetermined distance from the last line 75A of the printed area 75 denoted by shading in the figure, and the cut off printout is issued as a receipt or coupon, for example.

However, if the near-end has been detected (step S104 returns Yes), the control unit 140 determines if printing the near-end mark 165 is prohibited based on whether or not the prohibition flag is contained in the print data received from the host computer 90 (step S107). If printing the near-end mark 165 is prohibited (step S107 returns Yes), the control unit 140 goes to step S105 and finishes printing as usual, that is, without printing the near-end mark 165.

If printing the near-end mark 165 is not prohibited (step S107 returns No), the control unit 140 executes the following steps to inform the user that the end of the roll paper 7 is near by printing the near-end mark 165.

More specifically, in order to print the near-end mark 165 at or near the cutting position K of the roll paper 7 after printing, the control unit 140 advances the paper so that the thermal head 8 is positioned to the cutting position K (step S108). The mark changing unit 163 then gets the detected total paper feed distance of the roll paper 7 printed after the near-end was detected from the remaining roll paper monitoring unit, and based on this total paper feed distance determines the shape of the near-end mark 165 to be printed (step S109) Yet more specifically, this embodiment of the invention sets the remaining length of roll paper 7 when the near-end was first detected as the initial remainder, and considers the amount of paper in the range to 30% less than this initial remainder (that is, to 70% of the remainder) to be “long,” the amount from 30% to 70% less than the initial remainder (from 70% to 30%) to be “medium,” and the amount from 70% less than the initial remainder to no remainder (from 30% to 0) to be “short.” A different near-end mark 165 is assigned to each of these remaining lengths.

In the example shown in FIG. 10, a horizontal bar 166 is used as the near-end mark 165, and as shown in FIG. 10A to FIG. 10D, near-end marks 165 causing the length of the horizontal bar 166 to increase as the amount of remaining roll paper 7 decreases are preassigned to the long, medium, and short remaining lengths of roll paper 7. Data corresponding to these near-end mark 165 is stored in RAM in the control unit 140, for example, or included in the firmware 44.

In step S109 the mark changing unit 163 determines if the roll paper 7 remainder is long, medium, or short and selects the near-end mark 165 corresponding to the remaining length based on the total amount of roll paper 7 printed after the near-end was detected and the amount of roll paper 7 remaining (initial remainder) when the near-end was first detected. Note that the length of roll paper 7 remaining when the near-end is first detected is predefined as an approximate value based on the height at which the near-end detector 17 detects the roll paper 7 core, and this defined value is used as the initial remainder of the roll paper 7 when the near-end is first detected.

The control unit 140 then prints the near-end mark 165 selected by the mark changing unit 163 (step S110), and then continues to step S105 to advance and cut the roll paper 7.

As a result of this process as shown in FIG. 10, when the near-end is not detected, that is, when there is sufficient roll paper 7 remaining, a near-end mark 165 is not printed to the cutting position K of the roll paper 7 after printing (FIG. 10A), but after the near-end is detected, a horizontal bar 166 of a length corresponding to the amount of roll paper 7 remaining at that time is printed as a near-end mark 165 to the cutting position K of the roll paper 7 (FIG. 10B to FIG. 10D).

As described above, this embodiment of the invention is configured to print a near-end mark 165 to the cutting position K of the roll paper 7 after printing normally to the roll paper 7 when the near-end of the roll paper 7 has been detected by the near-end detector 17. This enables the user of the printer 201 to know from the appearance of the near-end mark 165 that the end of the roll paper 7 is near.

In addition, because the near-end of the roll paper 7 is reported by printing the near-end mark 165, it is not necessary to render near-end markings on the roll paper 7 during the paper manufacturing process as is required by the prior art. The productivity of the roll paper 7 manufacturing process is thus improved. The user can also be reliably informed of the near-end of the paper even when using roll paper 7 (such as linerless label paper) on which forming near-end markings can be difficult due to low affinity with the coating conventionally used to apply the near-end markings.

Furthermore, because the location where the near-end mark 165 is printed is limited to the cutting position K of the roll paper 7 in this embodiment of the invention, the near-end mark 165 is less conspicuous than the near-end markings conventionally printed in a band along an edge of the roll paper 7, and reporting the near-end can thus be made less intrusive and objectionable to a third party. In addition, if printing occupies the full width of the roll paper 7 and the near-end marking is printed along an edge of the roll paper 7, the marking can easily overlap the printed content. However, because this embodiment of the invention prints the near-end mark 165 at the cutting position K after printing the desired output content on the roll paper 7 has ended, the near-end mark 165 will not be superimposed with other printed content and the quality of the printout will not be impaired.

This embodiment of the invention is also configured to change the shape of the near-end mark 165 according to the length of remaining roll paper 7. This enables the user to know how much roll paper 7 is left based on the near-end mark 165 after the near-end has been detected. The user can also replace the roll paper 7 timed to when the roll paper 7 is sufficiently completely consumed to prevent running out of roll paper 7 while printing.

This embodiment also enables controlling whether or not the near-end mark 165 is printed according to the content of the printout. This enables not printing the near-end mark 165 only when it would interfere with the desired printout, such as when the value of the printout (such as a coupon) would be reduced by printing the near-end mark 165 or printing the near-end mark 165 in the desired printout would be annoying.

Note, further, that whether or not the near-end mark 165 is printed can be set based on conditions other than the printout. For example, printing the near-end mark 165 may be prohibited when using roll paper 7 on which near-end markings are already provided.

The second embodiment of the invention described above can also be modified as follows.

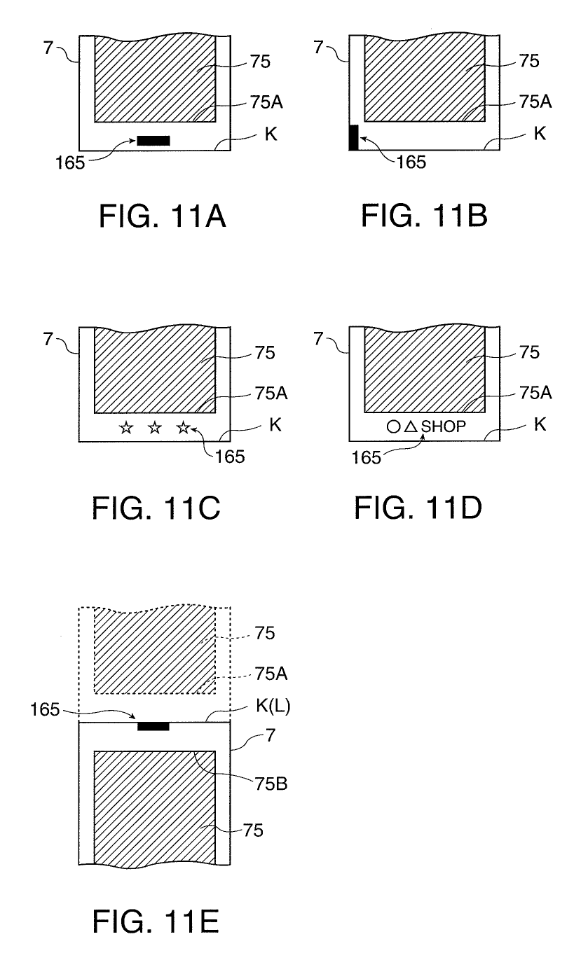

For example, the foregoing embodiment describes printing the near-end mark 165 at the cutting position K of the roll paper 7, but the invention is not so limited. More specifically, the near-end mark 165 can be printed anywhere that is after the printed area 75 and near the cutting position K. As shown in FIG. 11A, for example, the near-end mark 165 may be printed between the printed area 75 and the cutting position K. The printing position of the near-end mark 165 is also not limited to the middle of the roll paper 7, and may be printed near an edge as shown in FIG. 11B.

Any desirable image containing graphic elements, symbols, or characters, for example, can be used as the near-end mark 165 denoting the near-end of the paper. In addition to using an image containing a single element such as a horizontal bars 66 as the near-end mark 165, the near-end mark 165 may also be composed of a combination of plural image elements as shown in FIG. 11C, for example. The number and type of elements rendering the near-end mark 165 may also be changed according to how much roll paper 7 is left. As shown in FIG. 11D, a user-defined text string such as the name of the location issuing the printout may also be used as the near-end mark 165.

The invention is also not limited to printing the near-end mark 165 at a position between the printed area 75 and cutting position K, and the near-end mark 165 may, for example, be printed after the cutting position K, that is, at the leading end L of the roll paper 7 after the printed portion is cut off, as shown in FIG. 11E. In this configuration the near-end mark 165 is printed between the leading end L of the roll paper 7 and the beginning 75B of the printed area 75.

### Embodiment 3

A third embodiment of the invention is described next.

A printing system 300 according to this embodiment of the invention enables providing useful information to a third party while making the near-end notification unobtrusive and not annoying to the third party.

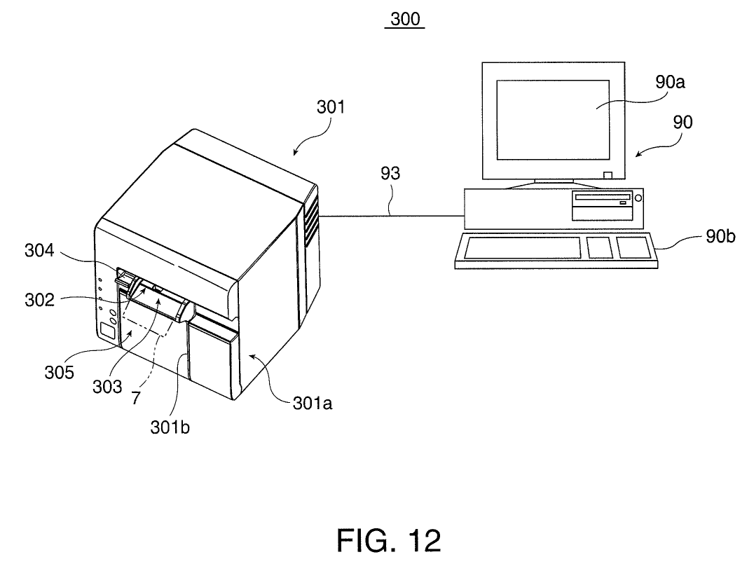

FIG. 12 shows the configuration of a printing system 300 according to this embodiment of the invention. Note that like parts in FIG. 12 and the first and second embodiments described above are identified by the same reference numerals, and further description thereof is omitted or simplified below.

The printing system 300 includes a host computer 90 as a host device, and a printer 301 that is connected to the host computer 90 through a communication cable 93. The printing system 300 is, for example, used advantageously for issuing receipts or coupons in a POS system used in restaurants and retail stores such as supermarkets.

The printer 301 uses roll paper 7, which is paper wound in a roll, as the recording medium, and is configured as an inkjet roll paper printer that prints by discharging ink to the printing surface of the roll paper 7.

The printer 301 has a substantially rectangular outside case 301a with a paper exit 302 of a specific width rendered in the front. An exit guide 303 protrudes to the front below the paper exit 302, and a cover opening/closing lever 304 is located beside the exit guide 303. A rectangular opening 301b is formed in the outside case 301a below the exit guide 303 and cover opening/closing lever 304, and this opening 301b is closed by an access cover 305 that opens forward.

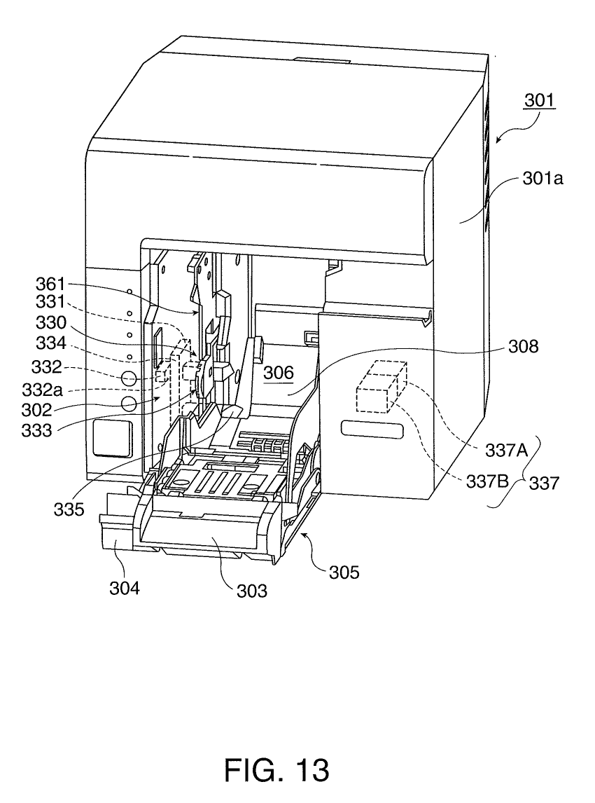

FIG. 13 is an oblique view of the printer 301 with the access cover 305 open.

When the cover opening/closing lever 304 is operated to release a cover locking mechanism not shown and the exit guide 303 is pulled forward, the access cover 305 swings forward to a substantially horizontal position as shown in FIG. 13 pivoting on its bottom end. When the access cover 305 is open the roll paper compartment 306 formed inside the printer 301 is open and the roll paper 7 can be replaced or loaded from the front of the printer. A near-end detector 330 for detecting when the end of the roll paper 7 is near (referred to as the “near-end” herein) is disposed to the side wall 361 on the right side of the roll paper compartment 306.

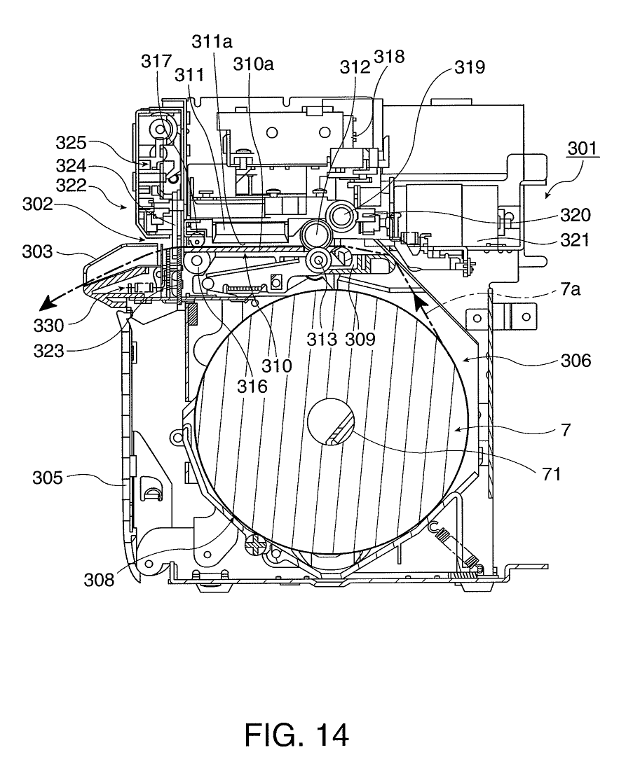

FIG. 14 is a vertical section view showing the inside structure of the printer 301 with the outside case 301a removed. The roll paper compartment 306 formed inside the printer 301 has a roll paper holder 308 that supports the roll paper 7 so that the roll can rotate freely. A paper guide 309 is disposed horizontally in the front-back direction of the printer at a position towards the back above the roll paper compartment 306. A platen guide 310 is disposed horizontally in the front-back direction of the printer at a slightly higher position in front of the paper guide 309. An inkjet head 311 is located directly above the platen guide 310. The nozzle surface 311a of the inkjet head 311 is disposed opposite the top surface 310a of the platen guide 310 with a constant gap therebetween, and the printing position is defined by the top surface 310a.

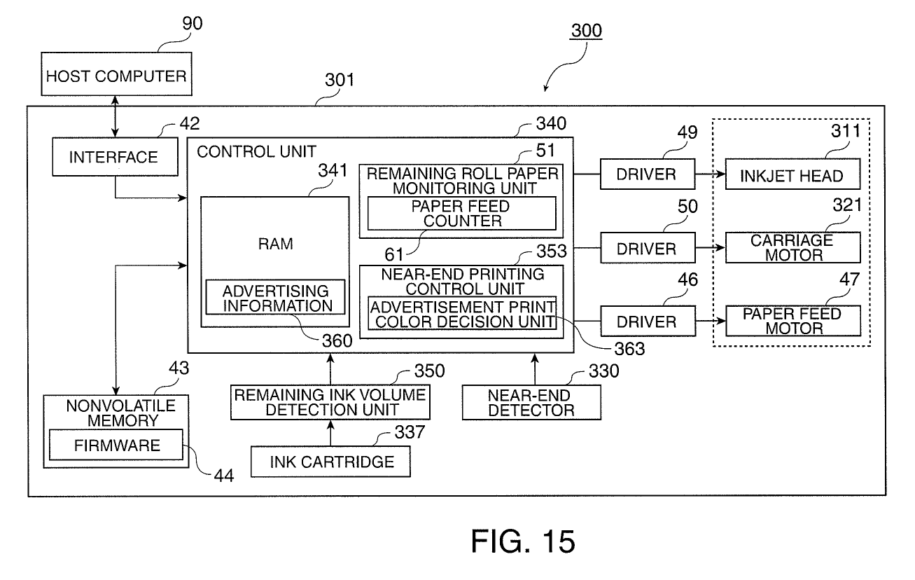

A first paper feed roller 312 extends horizontally widthwise to the printer between the paper guide 309 and the platen guide 310 that defines the printing position. A first pressure roller 313 of a specific width is pushed from below with a specific amount of pressure against the first paper feed roller 312. The first pressure roller 313 is driven by the paper feed motor 47 (FIG. 15) through a belt and pulley power transfer mechanism. A second paper feed roller 316 is located at a position at the front end side of the platen guide 310. A second pressure roller 317 is pressed from above against the second paper feed roller 316.

The inkjet head 311 is mounted on a carriage 318, and the carriage 318 is supported so that it can move widthwise to the printer (through the printing width) along a carriage guide 319 that extends horizontally widthwise to the printer. The carriage 318 is connected to a timing belt 320 that extends widthwise to the printer, and the timing belt 320 is driven by a carriage motor 321. When the carriage motor 321 is driven, the inkjet head 311 mounted on the carriage 318 moves widthwise to the printer. The inkjet head 311 is driven synchronously to this movement to print on the surface (recording surface) of the recording paper 7a that is delivered from the roll paper 7 passed the printing position.

Ink is supplied to the inkjet head 311 through an ink tube from an ink cartridge 337 (FIG. 13) stored in the ink cartridge storage unit. The ink cartridge 337 contains plural colors of ink, and in this embodiment of the invention has a black ink tank 337A that contains black ink and a red ink tank 337B that contains red ink.

As also shown in FIG. 14, a scissor type paper cutter 322 is disposed to the paper exit 302. The fixed knife 323 of the paper cutter 322 is position vertically with the cutting edge facing up, and the movable knife 324 is positioned vertically with the cutting edge facing down. When the movable knife 324 is caused to pivot vertically at a pivot point on one side of the printer by the movable knife drive mechanism 325, the point of contact with the fixed knife 323 moves widthwise to the printer and the recording paper 7a positioned therebetween can be cut across its width.

In a printer 301 thus comprised the recording paper 7a pulled from the roll paper 7 stored in the roll paper compartment 306 is guided by the paper guide 309 as indicated by the bold dot-dash line in FIG. 14. The recording paper 7a then travels from between the first paper feed roller 312 and first pressure roller 313 passed the top surface 310a (printing position) on the platen guide 310, between the second paper feed roller 316 and second pressure roller 317, and is set pulled to the outside from the paper exit 302.

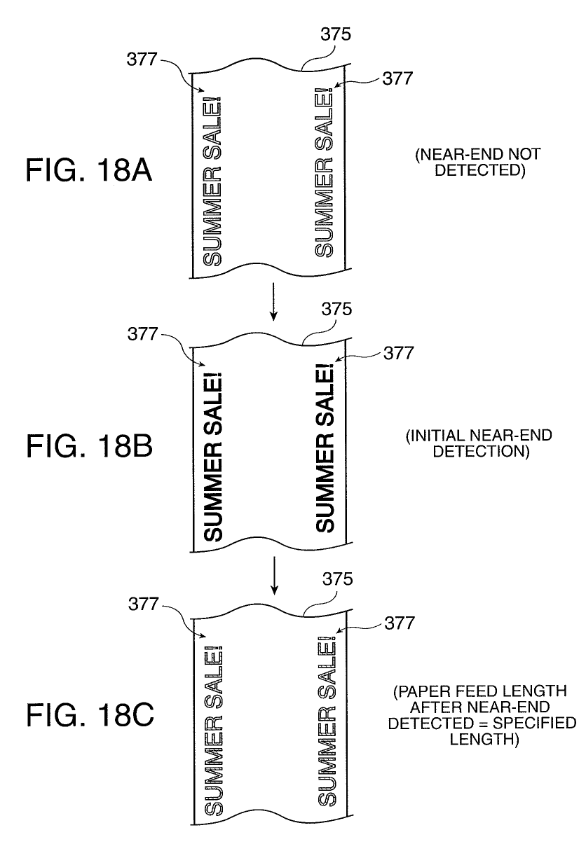

Conveying the recording paper 7a starts when the first paper feed roller 312 and second paper feed roller 316 turn. The inkjet head 311 is driven synchronized to conveying the recording paper 7a to print on the surface of the recording paper 7a passing the printing position. Paper transportation stops with a length of the printed recording paper 7a discharged from the paper exit 302, the recording paper 7a is cut by the paper cutter 322, and the printed portion of a particular length is issued as a receipt 375 (FIG. 18).

As shown in FIG. 13, the near-end detector 330 has a rotary lever 331 extending vertically to the printer and a limit switch 332 that are attached to a detector bracket 333. The rotary lever 331 is supported on the detector bracket 333 so that it can pivot widthwise to the printer on a pivot pin 334 attached to its top end part. A detection finger 335 that protrudes into the roll paper compartment 306 is formed on the bottom end part of the rotary lever 331.

When roll paper 7 with a sufficient remaining length of paper is in the roll paper compartment 306, the detection finger 335 and tab 336 contact the end of the roll paper 7 below the core 71 (FIG. 14) and the rotary lever 331 is pushed out to the side. As the roll paper 7 is consumed, the outside diameter of the roll paper 7 decreases and the position of the core 71 gradually descends. When the height of the core 71 descends to the height of the detection finger 335, the detection finger 335 enters the core 71 and the rotary lever 331 pivots to the roll paper compartment side.

The detection rod 332a of the limit switch 332 attached to the detector bracket 333 urges the rotary lever 331 by the force of an internal spring to the roll paper compartment side. Because the rotary lever 331 is pushed out to the side when the roll paper 7 is loaded, the detection rod 332a is pushed in. In this state the limit switch 332 is off and the remaining amount of roll paper 7 decreases therefrom as described above. When the height of the core 71 descends to the height of the detection finger 335, the rotary lever 331 that is pushed by the detection rod 332a pivots to the inside, and the detection finger 335 enters the core 71. As a result, the limit switch 332 turns on and outputs a detection signal indicating the near-end of the roll paper 7. The height of the detection finger 335 can be adjusted, and the user can adjust the height of the detection finger 335 to adjust how much roll paper 7 is left when a near-end is first detected.

FIG. 15 is a function block diagram of the printing system 300. Note that like parts in FIG. 15 and the block diagram used to described the first and second embodiments above are identified by the same reference numerals, and further description thereof is omitted or simplified below. The near-end detector 330 and a remaining ink volume detection unit 350 are connected to the input side of the control unit 340 of the printer 301. The control unit 340 detects the near-end of the roll paper 7 based on input signals from the near-end detector 330. The remaining ink volume detection unit 350 inputs detection signals indicating how much of each color of ink remains in the ink cartridge 337 to the control unit 340. More specifically, the remaining ink volume detection unit 350 inputs remaining ink volume signals for both the black ink tank 337A and red ink tank 337B of the ink cartridge 337. The inkjet head 311 (print unit), carriage motor 321, and paper feed motor 47 are connected to the output side of the control unit 340 through a head driver 49 and motor drivers 46 and 50.

The control unit 340 controls printing on the roll paper 7, and includes RAM 341, a remaining roll paper monitoring unit 51 and a near-end printing control unit 353.

Advertising information 360 is stored in advance to RAM 341. This advertising information 360 is advertising information for particular products or sales campaigns in the store or restaurant, for example, where the printer 301 is used, and is input from the host computer 90. The advertising information 360 is printed as an advertisement 377 (FIG. 18) in empty space on the printed page when issuing a receipt 375 (FIG. 18).

Substitute information such as the store name that can be printed instead of the advertising information 360 is also stored in advance in RAM 341 or nonvolatile memory 43, and this substitute information is used when advertising information 360 is not input from the host computer 90.

The remaining roll paper monitoring unit 51 is identical to the remaining roll paper monitoring unit 51 described in the first embodiment, and monitors the paper feed distance of the roll paper 7 after the near-end is detected by the near-end detector 330. More specifically, the remaining roll paper monitoring unit 51 has a paper feed counter 61. The paper feed counter 61 counts the number of steps that the paper feed motor 47 is controlled to drive in the paper feed direction. The remaining roll paper monitoring unit 51 monitors the total paper feed distance of the roll paper 7 by calculating the total number of steps (cumulative total) counted by the paper feed counter 61.

When the near-end is detected by the near-end detector 330, the near-end printing control unit 353 controls changing the color used to print the advertising information 360 that is printed with the transaction information by the inkjet head 311 on the receipt 375 (FIG. 18) issued after the near-end is detected. The near-end printing control unit 353 has an advertisement print color decision unit 363. The advertisement print color decision unit 363 decides what color to use when the color of the advertising information 360 is changed.

More particularly, the advertisement print color decision unit 363 changes the color by changing the print color of the advertising information 360 to a different color, by changing the density of the same color, or by changing the saturation, for example. Changing to a different color changes the hue from black to red, for example. Changing the density of the same color changes the brightness from a dark black to a light black, for example. Changing the saturation changes from a bright red to a muted red, for example.

The advertisement print color decision unit 363 determines how the color of the advertising information 360 is changed according to how much roll paper 7 remains and how much of each color of ink remains in the ink cartridge 337, thereby enabling the user to know from the printed color of the advertising information 360 how much roll paper 7 is left while also using each color of each evenly.

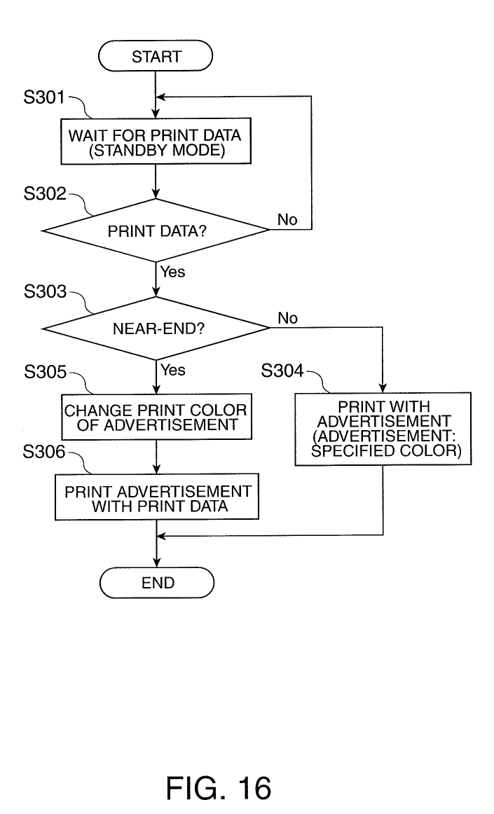

The printing operation of the printer 301 is described next with reference to FIG. 16.

The control unit 340 enters a standby mode when the power turns on (step S301), and waits to receive print data from the host computer 90 (step S302 returns No). This standby mode is used to input the advertising information 360 from the host computer 90 to the printer 301. When the control unit 340 receives print data from the host computer 90 while in the standby mode (step S302 returns Yes), it determines if the near-end of the roll paper 7 has been detected by the near-end detector 330 (step S303).

If the near-end has not been detected (step S303 returns No), the remaining amount of roll paper 7 is sufficient and normal printing proceeds as usual according to the print data. More specifically, the control unit 340 prints on the roll paper 7 based on the text data and image data contained in the print data to be printed and prints an advertisement 377 in empty space on the printing surface based on the advertising information 360 stored in RAM 341 (step S304). The advertisement 377 is printed in the preset color at this time.

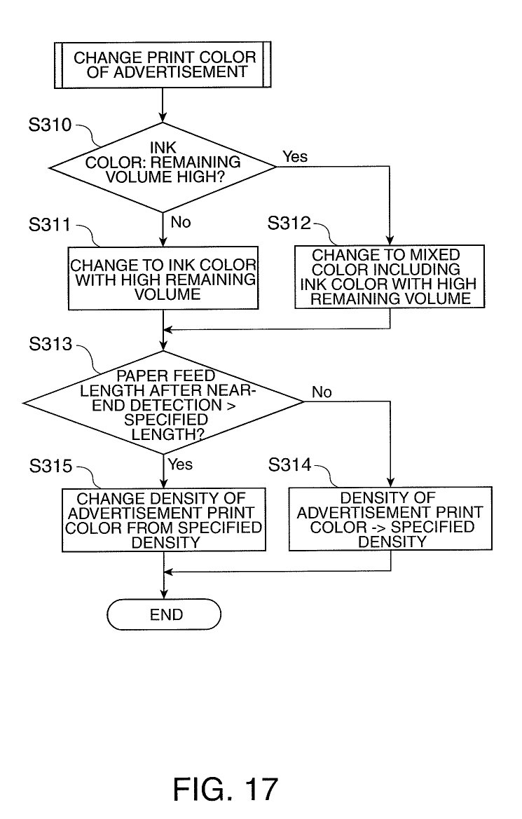

If the near-end has been detected (step S303 returns Yes), the print color of the advertisement 377 is changed to the color determined by the advertisement print color decision unit 363 (step S305). More specifically, as shown in FIG. 17, the advertisement print color decision unit 363 determines if the ink used as the specified print color of the advertisement 377 is the same as the ink of the greatest remaining volume in the ink cartridge 337 (step S310).

If the ink specified for printing and the ink with the greatest remaining volume are not the same (step S310 returns No), the advertisement print color decision unit 363 changes the print color to the ink with the greatest remaining volume so that the amount of remaining ink is made substantially the same for each color (step S311). For example, if the specified color of the advertisement 377 is black and there is more red ink left than black ink, the print color of the advertisement 377 is changed to red.

If the ink specified for printing and the ink with the greatest remaining volume are the same color (step S310 returns Yes), the advertisement print color decision unit 363 changes the print color to a mixed color using the specified color of ink and the ink with the next largest remaining volume so that the amount of remaining ink is closer to the same for each color (step S312). For example, if the specified color of the advertisement 377 is red and there is more red ink left than black ink, the print color of the advertisement 377 is changed to a mixture of red and black. Note that if the ink cartridge 337 holds three or more colors of ink, the color can be changed to a mixture of the three inks with the greatest volume, or the print color can be changed to the ink with the second largest volume instead of mixing colors.

The advertisement print color decision unit 363 then gets the total amount of roll paper 7 printed after the near-end was detected (the total paper feed distance) from the remaining roll paper monitoring unit 51, and determines if this total distance has reached a specified level (step S313). This specified level is determined referenced to an amount where the remaining roll paper 7 is minimal and is approximately enough to print two or three more receipts before the roll paper 7 runs out. This amount is, for example, equivalent to a specified percentage (such as 80% or 90%) of the amount (length) of roll paper 7 remaining when a near-end is first detected.

If the total amount of roll paper 7 printed after the near-end was detected has not reached this specified level (step S313 returns No), the advertisement print color decision unit 363 sets the density of the print color of the advertisement 377 to a predetermined density (step S314). If it has reached this specified level (step S313 returns Yes), the advertisement print color decision unit 363 changes the density of the print color of the advertisement 377 from the specified density, and in this embodiment of the invention changes the density to a lighter density (step S315).

Referring again to FIG. 16, the control unit 340 then prints the advertisement 377 in the print color determined by the advertisement print color decision unit 363 together with the transaction information on the receipt 375 (step S306).

As a result of this operation, when an advertisement is printed along both edges of the advertisement 377 as shown in FIG. 18, and the near-end has not been detected, that is, there is sufficient roll paper 7 remaining, the advertisement 377 is printed in the predetermined color (using black outline characters in this example, FIG. 18A). When the near-end is then detected, the print color of the advertisement 377 is changed from the specified color to the color determined by the process described in FIG. 17 as shown in FIG. 18B. When the total paper feed distance of the roll paper 7 after the near-end is detected reaches the specified level, the density of the advertisement 377 is also changed as shown in FIG. 18C.

This embodiment of the invention has the following effect.

This embodiment of the invention also prints an advertisement 377 in a specified print color while printing to roll paper 7, and changes the print color of the advertisement 377 when the near-end is detected by the near-end detector 330. As a result, the user of the printer 301 can know that the end of the roll paper 7 is near from the change in the print color of the advertisement 377. Third parties other than the user will simply recognize the advertisement 377 as an advertisement, which is printed without interfering with other content. More particularly, the advertisement 377 will be received as useful information.

In addition, because the near-end of the roll paper 7 is reported by printing an advertisement 377, it is not necessary to render near-end markings on the roll paper 7 during the paper manufacturing process as is required by the prior art. The productivity of the roll paper 7 manufacturing process is thus improved. The user can also be reliably informed of the near-end of the paper even when using roll paper 7 (such as linerless label paper) on which forming near-end markings can be difficult due to low affinity with the coating conventionally used to apply the near-end markings.

This embodiment of the invention is also configured to change the color used to print the advertisement 377 according to the length of remaining roll paper 7 after the near-end is detected. This embodiment enables the user to know how much roll paper 7 is left based on the color of the advertisement 377. The user can also replace the roll paper 7 timed to when the roll paper 7 is sufficiently completely consumed to prevent running out of roll paper 7 while printing.

When the print color of the advertisement 377 is changed after the near-end is detected, the print color is determined according to how much ink of each color is left in the ink cartridge 337, and more particularly changes the print color of the advertisement 377 to the color of the ink with the largest remaining volume. This causes the ink with the greatest volume to be consumed so that the remaining ink volumes can be evened out. The ink cartridge 337 can then be replaced after each color of ink is sufficiently depleted.

### Embodiment 4

The third embodiment described above always prints an advertisement 377 on the roll paper 7, but this embodiment of the invention only prints the advertisement 377 after the near-end of the roll paper 7 is detected. The configuration of the printer in this embodiment of the invention is substantially identical to the configuration of the third embodiment, and further description thereof is thus omitted.

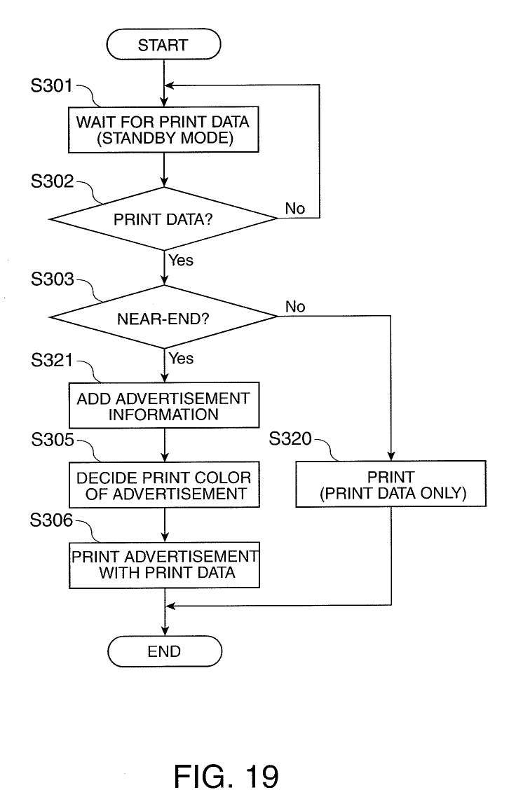

FIG. 19 is a flow chart of the printing operation in this embodiment of the invention. Steps that are the same as in the foregoing third embodiment are identified by the same reference numbers.

As shown in FIG. 19, when the near-end is not detected (step S303 returns No), the control unit 340 prints only the normal transaction information, for example, contained in the print data and does not print the advertisement 377 (step S320).

If the near-end has been detected (step S303 returns Yes), the control unit 340 adds the advertising information 360 to the information contained in the print data (step S321), and prints an advertisement 377 based on the advertising information 360 together with the normal transaction information, for example. As in the third embodiment, the print color of the advertisement 377 is determined by the advertisement print color decision unit 363 according to how much roll paper 7 is left and how much of each color of ink is left in the ink cartridge 337 (step S305), and the advertisement 377 is printed in the selected print color together with the normal transaction information (step S306).

In addition to the effect of the third embodiment, this embodiment has the following effect. That is, because an advertisement 377 is also printed when printing on the roll paper 7 after the near-end is detected, the user can know that the end of the roll paper 7 is near from the appearance of an advertisement 377 on the roll paper 7. Third parties other than the user will simply recognize the advertisement 377 as an advertisement while the user can be informed that the end of the paper is near.

The third and fourth embodiments of the invention can be modified as described below.

For example, the third and fourth embodiments describe a printing device having an inkjet head 311 as a printer that prints on roll paper 7, but the invention is not so limited and the printing device may have a thermal head 8 in the printing unit. This type of printing device uses paper having layers that produce different colors according to the applied heat as the roll paper 7, and the print color of the advertisement 377 is changed by controlling the heat applied to the roll paper 7 by the thermal head 8.

Similarly to the first and second embodiments, the third and fourth embodiments may also change the content of the advertisement 377 according to how much roll paper 7 is left. Also similarly to the first and second embodiments, the third and fourth embodiments may be configured to enable setting whether or not the printer 301 prints an advertisement 377. Whether or not an advertisement 377 is printed may also be configured according to the content of the printout.

The printing system 300 and printer 301 described as a printing device in the third and fourth embodiments are also not limited to POS systems, and can be used in automatic teller machines (ATM) and cash dispensers (CD).

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1. A printing device comprising:
a printing unit that prints print data on roll paper;
a near-end detection unit that detects the near-end of the roll paper; and
a printing control unit that causes the printing unit to print a near-end pattern, mark, or advertisement indicating the near-end when printing on the roll paper after the near-end has been detected by the near-end detection unit.

2. The printing device described in claim 1, further comprising:
a cutting unit that cuts the roll paper printed by the printing unit;
the printing control unit causing the printing unit to print the mark denoting the near-end at or near the cutting position of the cutting unit.

3. The printing device described in claim 1, wherein:
the printing control unit causes the printing unit to change and print a near-end pattern, mark, or advertisement according to how much roll paper remains.

4. The printing device described in claim 1, further comprising:
a configuration unit for setting whether or not to print the near-end pattern, mark, or advertisement.

5. The printing device described in claim 4, wherein:
the configuration unit sets whether or not to print the near-end pattern, mark, or advertisement according to the printout.

6. The printing device described in claim 1, wherein:
the printing control unit causes the printing unit to print the advertisement in a specified print color when printing the print data on the roll paper, and when the near-end is detected by the near-end detection unit, causes the printing unit to print an advertisement indicating the near-end by changing the print color of the advertisement.

7. The printing device described in claim 6, wherein:
the printing control unit determines the print color according to how much roll paper remains when changing the print color of the advertisement.

8. The printing device described in claim 6, wherein:
the printing unit comprises
an inkjet head that discharges ink to the printing surface of the roll paper, and
an ink cartridge that stores ink of plural colors and supplies the ink to the inkjet head; and
the printing control unit determines the print color according to how much of each color of ink remains in the ink cartridge when changing the print color of the advertisement.

9. A printing system comprising:
a host device that generates print data; and
a printing device having
a printing unit for printing print data sent from the host device on roll paper,
a near-end detection unit that detects the near-end of the roll paper, and
a printing control unit that causes the printing unit to print a near-end pattern, mark, or advertisement indicating the near-end when printing on the roll paper after the near-end has been detected by the near-end detection unit.

10. The printing system described in claim 9, further comprising wherein the printing device further comprises:
a cutting unit that cuts the roll paper printed by the printing unit; and
the printing control unit causing the printing unit to print the mark denoting the near-end at or near the cutting position of the cutting unit.

11. The printing system described in claim 9, wherein:
the printing control unit causes the printing unit to print the advertisement in a specified print color when printing the print data on the roll paper, and when the near-end is detected by the near-end detection unit, causes the printing unit to print an advertisement indicating the near-end by changing the print color of the advertisement.

12. A near-end notification method for a printing device that prints print data on roll paper, comprising a step of:
printing a near-end pattern, mark, or advertisement indicating a near-end when printing on the roll paper after the near-end of the roll paper has been detected.

13. The near-end notification method described in claim 12, wherein the mark denoting the near-end is printed at or near the cutting position where the roll paper on which the print data is printed is cut.

14. The near-end notification method described in claim 12, wherein the near-end pattern, mark, or advertisement is changed and printed according to how much roll paper remains.

15. The near-end notification method described in claim 12, wherein:
the advertisement is printed in a specified print color when printing the print data on the roll paper, and when the near-end is detected by the near-end detection unit, an advertisement indicating the near-end is printed by changing the print color of the advertisement.
